(19) United States
(12) Patent Application Publication
(10) Pub. No.: US 2015/0228999 A1
(43) Pub. Date: Aug. 13, 2015

(54) Method for Forming an Electrochemical Cell, an Electrochemical Cell and Battery

(71) Applicant: Li-Tec Battery GmbH, Kamenz (DE)

(72) Inventors: Tim Schaefer, Niedersachswerfen (DE); Magnus Mickel, Wittichenau (DE); Markus Wohnig, Dresden (DE); Iris Stiebert, Dresden (DE)

(21) Appl. No.: 14/420,212

(22) PCT Filed: Jul. 25, 2013
(86) PCT No.: PCT/EP2013/002216

§ 371 Date: Feb. 6, 2015

Related U.S. Application Data
(60) Provisional application No. 61/680,315, filed on Aug. 7, 2012.

(30) Foreign Application Priority Data
Aug. 7, 2012 (DE) 10 2012 015 575.1
Sep. 10, 2012 (DE) 10 2012 017 829.8

(51) Int. Cl. H01M 10/04

(52) U.S. Cl. CPC H01M 10/049; H01M 2220/20

(57) ABSTRACT

A method for forming an electrochemical cell involves pressing a first contact element of a forming unit onto a first forming contact-making section of a first conductor of the cell, pressing a second contact element of the forming unit onto the second forming contact-making section of the second conductor of the cell, carrying out a forming treatment on the cell, separating the first forming contact-making section from the first conductor, and separating the second forming contact-making section from the second conductor.

### BACKGROUND AND SUMMARY OF THE INVENTION

Exemplary embodiments of the invention relate to a method for forming an electrochemical cell for a battery preferably configured for use in motor vehicles, and to a correspondingly formed electrochemical cell and a battery comprising these electrochemical cells.

The entire content of the priority applications DE 10 2012 015 575 and DE 10 2012 017 828 is hereby incorporated by reference in the present patent application.

It is known in the manufacture of electrochemical cells to subject the cells to a formation process for the purpose of improving their properties. The forming comprises a preferably repeated charging and discharging of the electrochemical cells. Different methods of forming electrochemical cells as well as the correspondingly formed electrochemical cells and batteries comprising these electrochemical cells are known from the prior art. Improved methods for forming electrochemical cells are desirable, particularly for use in motor vehicles.

Accordingly, exemplary embodiments of the present invention are directed to an improved method for forming electrochemical cells as well as to provide correspondingly formed electrochemical cells and batteries, respectively.

An exemplary embodiment of the invention is directed to a method for forming an electrochemical cell, the electrochemical cell comprising a first conductor and a second conductor for a battery preferably configured for use in motor vehicles, by means of a forming unit comprising a first contact element and a second contact element, wherein the first conductor has a first forming contact-making section designed in a separable manner, and the second conductor has a second forming contact-making section designed in a separable manner, in that the method comprises the following steps: a step of pressing the first contact element of the forming unit onto the first forming contact-making section of the first conductor, a step of pressing the second contact element of the forming unit onto the second forming contact-making section of the second conductor, a step of carrying out a forming treatment, a step of separating the first forming contact-making section from the first conductor and a step of separating the second forming contact-making section from the second conductor. An advantage of this configuration is that the contact between the forming unit and the electrochemical cell and therefore its formation can be improved. Another advantage of this configuration is that the formation process can be accelerated since—without negatively impacting the final state of the first conductor or the final state of the second conductor—the forming contact-making sections can optionally be subjected to higher charges during the formation process.

In the present invention, an electrochemical cell is to be understood as an electrochemical energy storage, thus a device that can store energy in chemical form, can release it in electrical form to a load and preferably can absorb it in electrical form from a charging device. Important examples of such electro-chemical energy storages are galvanic cells or fuel cells. The electrochemical cell has at least one first and one second device for storing electrically different charges, which devices are configured as an electrode assembly, as well as a means for establishing an operative electrical connection between these two devices, wherein charge carriers can be displaced between these two devices. For example, an electrolyte acting as an ion conductor can be understood as the means for establishing an operative electrical connection.

The method step of pressing the first contact element is preferably carried out in such a manner that the surface layers of the first forming contact-making section are pierced through. The method step of pressing the second contact element is moreover preferably carried out in such a manner that surface layers of the second forming contact-making section are pierced through. An advantage of these configurations is that the contact resistance can be reduced and, as a result, contacting and forming can be improved.

In the method, the first contact element of the forming unit preferably has at least one tip. Furthermore, the second contact element in the method preferably has at least one tip. An advantage of these configurations is that the contact can be improved in a particularly simple manner.

In the method, the first contact element is preferably configured as a first number of first contact pins, wherein it is particularly preferable for the first contact element to comprise three first contact pins. According to a further preferred exemplary embodiment, only one first contact pin is formed on the first contact element. Furthermore, the second contact element in the method is preferably configured as a second number of second contact pins, wherein it is particularly preferable for the second contact element to comprise three second contact pins. According to a further preferred exemplary embodiment, only one second contact pin is formed on the second contact element.

In the method, the first contact pins are preferably mounted individually. Furthermore, the second contact pins are preferably mounted individually in said method. An advantage of this configuration is that the pressure can be adapted particularly well so as to further reduce the contact resistance.

In the method, the first contact element preferably comprises on its contacting end at least one cap having contact spikes, wherein it is particularly preferable for the first contact element to comprise three caps with preferably four contact spikes. It is further preferable for the second contact element to comprise on its contacting end at least one cap having contact spikes, wherein it is particularly preferential for the second contact element to comprise three caps with preferably four contact spikes. An advantage of this configuration is that it is possible in a particularly simple manner to effectively improve the contact.

After the step of pressing the first contact element, the method preferably further comprises the following steps: a step of detecting first parameter data of the first contact between the first contact element of the forming unit and the first forming contact-making section of the first conductor, a step of feeding the detected first parameter data to a controller, and a step of carrying out a first change to the contact in dependence on the detected first parameter data when the detected first parameter data exhibits a predetermined first threshold value.

After the step of pressing the second contact element, the method preferably further comprises the following steps: a step of detecting second parameter data of the second contact between the second contact element of the forming unit and the second forming contact-making section of the second conductor, a step of feeding the detected second parameter data to a controller, and a step of carrying out a second change to the contact in dependence on the detected second parameter data when the detected second parameter data exhibits a predetermined second threshold value. An advantage of this configuration is that during the formation, the contact can be maintained in a simpler manner in the desired quality.

In the method, the step of detecting first parameter contact data preferably comprises at least one of the following steps: a step of detecting a first transition resistance of the first contact between the first contact element of the forming unit and the first forming contact-making section of the first conductor, and/or a step of detecting a first temperature of the first contact between the first contact element of the forming unit and the first forming contact-making section of the first conductor. It is furthermore preferable in the method that the step of detecting second parameter contact data comprises at least one of the following steps: a step of detecting a second transition resistance of the second contact between the second contact element of the forming unit and the second forming contact-making section of the second conductor, and/or a step of detecting a second temperature of the second contact between the second contact element of the forming unit and the second forming contact-making section of the second conductor.

In the method, the step of carrying out a first contact change preferably comprises the following step: a step of increasing a first pressure with which the first contact element is pressed onto the first forming contact-making section of the first conductor. Furthermore, the method provides that the step of carrying out a second contact change preferably comprises the following step: a step of increasing a second pressure with which the second contact element is pressed onto the second forming contact-making section of the second conductor.

In the method, the step of carrying out a forming process preferably comprises the following steps: a step of carrying out a first forming of the electrochemical cell in a range of 25 to 40% of nominal capacity, a step of carrying out a second forming of the electrochemical cell in a range of 75 to 90% of nominal capacity, and a step of carrying out a third forming of the electrochemical cell to 100% nominal capacity. An advantage of this configuration is that the capacity of the formatted electrochemical cell can be increased.

Furthermore, exemplary embodiments of the present invention are directed to an electrochemical cell comprising a first conductor having a first forming contact-making section designed in a separable manner and comprising a second conductor having a second forming contact-making section designed in a separable manner, in that the electrochemical cell has been formed by means of an above-described method.

The first forming contact-making section for the electrochemical cell is preferably arranged on an outer end of the first conductor. Furthermore, the second forming contact-making section is preferably arranged on an outer end of the second conductor. An advantage of this configuration is that after the forming treatment, separating the first forming contact-making section from the first conductor and/or separating the second forming contact-making section from the second conductor can be carried out in a better way.

Furthermore, exemplary embodiments of the present invention are directed to a battery comprising an electrochemical cell in that the electrochemical cell of the battery has been formed by means of an above-described method.

### BRIEF DESCRIPTION OF THE DRAWING FIGURES

Aspects of the invention are described in more detail below based on preferred exemplary embodiments and by means of the figures. In the figures:

FIG. 1 shows a flow chart of a method for forming electrochemical cells according to an exemplary embodiment,

FIG. 2a shows a first detailed illustration of the flow chart shown in FIG. 1 with respect to the detecting of first parameter data,

FIG. 2b shows a second detailed illustration of the flow chart shown in FIG. 1 with respect to the detecting of second parameter data, and

FIG. 3 shows a third detailed illustration of the flow chart shown in FIG. 1 with respect to carrying out a forming treatment according to a preferred exemplary embodiment.

### DETAILED DESCRIPTION

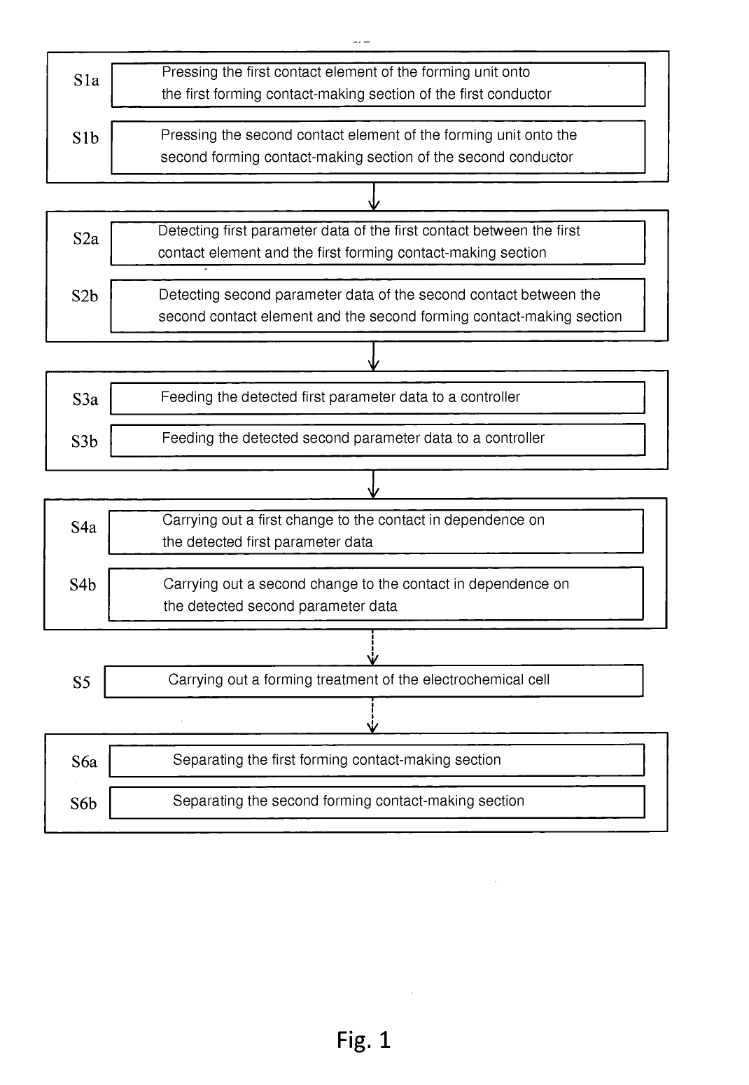

FIG. 1 shows a flow chart for a method for forming an electrochemical cell according to an exemplary embodiment of the present invention. The electrochemical cell comprises a first conductor having a first forming contact-making section and a second conductor having a second forming contact-making section. The forming unit comprises a first contact element for the first forming contact-making section of the first conductor and a second contact element for the second forming contact-making section of the second conductor.

In a step S1a, the first contact element of the forming unit is pressed onto the first forming contact-making section of the first conductor. In a step S1b, the second contact element of the forming unit is pressed onto the second forming contact-making section of the second conductor, wherein steps S1a and S1b can be carried out simultaneously or in a freely selectable order relative to one another.

According to a preferred exemplary embodiment, first parameter data of the first contact between the first contact element of the forming unit and the first forming contact-making section of the first conductor is detected in step S2a.

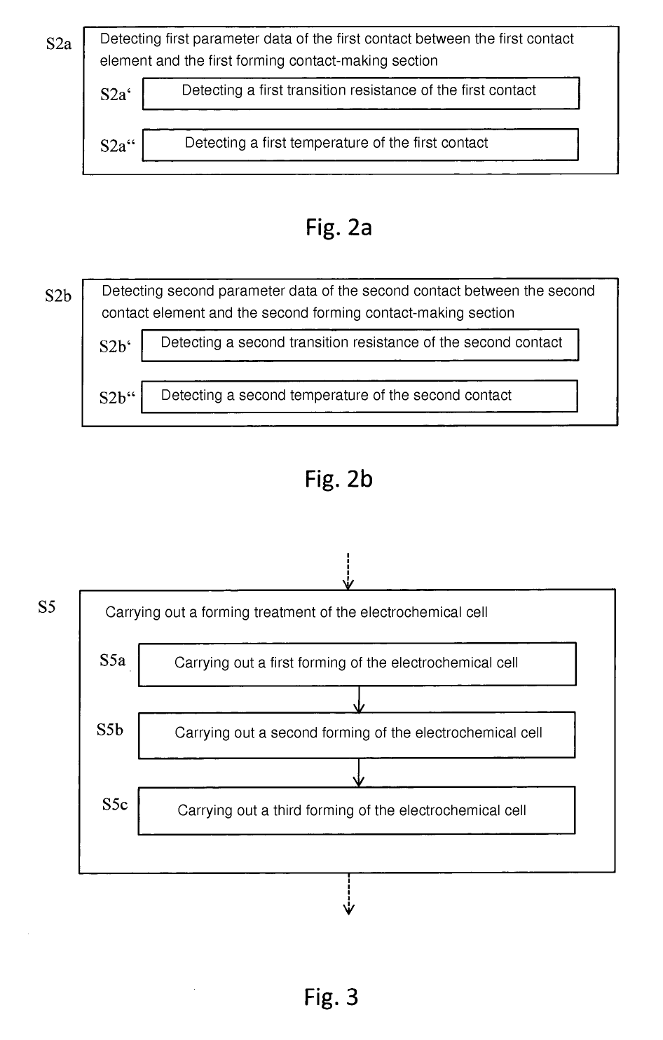

As is apparent from FIG. 2a, the step S2a of detecting the first parameter data can include a step 2a′ of detecting a first transition resistance of the first contact between the first contact element of the forming unit and the first forming contact-making section of the first conductor and/or a step 2a″ of detecting a first temperature of the first contact between the first contact element of the forming unit and the first forming contact-making section of the first conductor.

Furthermore, according to the preferred exemplary embodiment, second parameter data of the second contact between the second contact element of the forming unit and the second forming contact-making section of the second conductor can be detected in a step 2b, wherein steps S2a and S2b can be carried out simultaneously or in a freely selectable order relative to one another other.

As is apparent from FIG. 2b, the step S2b of detecting the second parameter data can include a step 2b′ of detecting a second transition resistance of the second contact between the second contact element of the forming unit and the second forming contact-making section of the second conductor and/or a step 2b″ of detecting a second temperature of the second contact between the second contact element of the forming unit and the second forming contact-making section of the second conductor.

As is further apparent from FIG. 1, in a preferred exemplary embodiment, the detected first parameter data can be fed to a controller in a step S3a, and the detected second parameter data can be fed to a controller in a step S3b, wherein steps S3a and S3b can be carried out simultaneously or in a freely selectable sequence relative to one another.

In these exemplary embodiments, a change to the first contact can be carried out in dependence on the detected first parameter data in a step S4a when the detected first parameter data exhibits a predetermined first threshold value. Furthermore, in a step S4b, a change to the second contact can be carried out in dependence on the detected second parameter data when the detected second parameter data exhibits a predetermined second threshold value, whereby steps S4a and S4b can be carried out simultaneously or in a freely selectable order relative to one another.

According to an exemplary embodiment not illustrated in the figures, step S4a of carrying out a change to the first contact can include a step S4a′ of increasing a first pressure with which the first contact element is pressed onto the first forming contact-making section of the first conductor. Furthermore, step S4b of carrying out a change to the second contact can include a step S4b′ of increasing a second pressure with which the second contact element is pressed onto the second forming contact-making section of the second conductor.

FIG. 1 shows that in the method according to the present invention, a forming treatment of the electrochemical cell is carried out in a step S5, and FIG. 3 shows a flow chart of a preferred exemplary embodiment for carrying out the forming treatment of electrochemical cells. In a step S5a, a first forming of the electrochemical cell is carried out, preferably in a range of 25-40% of nominal capacity, and in a step S5b, a second forming of the electrochemical cell is carried out, preferably in a range of 75-90% of nominal capacity, and in a step S5c, a third forming of the intermediate electrochemical cell product is carried out, preferably to 100% nominal capacity.

In the method according to the present invention, after step S5 of carrying out a forming treatment of the electrochemical cell, the first forming contact-making section is separated in step S6a, and the second forming contact-making section is separated in step S6b, wherein steps S6a and S6b can be carried out simultaneously or in a freely selectable order relative to one another other.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof

### REFERENCE LIST

S1a pressing the first contact element of the forming unit onto the first forming contact-making section of the first conductor
S1b pressing the second contact element of the forming unit onto the second forming contact-making section of the second conductor
S2a detecting first parameter data of the first contact between the first contact element of the forming unit and the first forming contact-making section of the first conductor
S2a′ detecting a first transition resistance of the first contact between the first contact element of the forming unit and the first forming contact-making section of the first conductor
S2a″ detecting a first temperature of the first contact between the first contact element of the forming unit and the first forming contact-making section of the first conductor
S2b detecting second parameter data of the second contact between the second contact element of the forming unit and the second forming contact-making section of the second conductor
S2b′ detecting a second transition resistance of the second contact between the second contact element of the forming unit and the second forming contact-making section of the second conductor
S2b″ detecting a second temperature of the second contact between the second contact element of the forming unit and the second forming contact-making section of the second conductor
S3a feeding the detected first parameter data to a controller
S3b feeding the detected second parameter data to a controller
S4a carrying out a first change to the contact in dependence on the detected first parameter data when the detected first parameter data exhibits a predetermined first threshold value
S4a′ increasing a first pressure with which the first contact element is pressed onto the first forming contact-making section of the first conductor
S4b carrying out a second change to the contact in dependence on the detected second parameter data when the detected second parameter data exhibits a predetermined second threshold value
S4b′ increasing a second pressure with which the second contact element is pressed onto the second forming contact-making section of the second conductor
S5 carrying out a forming treatment
S5a carrying out a first forming of the electrochemical cell in a range of 25-40% of nominal capacity
S5b carrying out a second forming of the electrochemical cell in a range of 75-90% of nominal capacity
S5c carrying out a third forming of the electrochemical cell to 100% nominal capacity
S6a separating the first forming contact-making section
S6b separating the second forming contact-making section

1-13. (canceled)

14. A method for forming an electrochemical cell, the electrochemical cell of a motor vehicle battery comprising a first conductor and a second conductor, by a forming unit comprising a first contact element and a second contact element, wherein the first conductor comprises a first forming contact-making section designed in a separable manner, and the second conductor comprises a second forming contact-making section designed in a separable manner, the method comprising the steps:
pressing the first contact element of the forming unit onto the first forming contact-making section of the first conductor;
pressing the second contact element of the forming unit onto the second forming contact section of the second conductor;
carrying out a forming treatment on the electrochemical cell;
separating the first forming contact-making section from the first conductor; and
separating the second forming contact-making section from the second conductor.

15. The method of claim 14, wherein
the step of pressing the first contact element is carried out in such a manner that surface layers of the first formation contact section are pierced through; or
the step of pressing the second contact element is carried out in such a manner that surface layers of the second forming contact-making section are pierced through.

16. The method of claim 14, wherein the first contact element of the forming unit comprises at least one tip, and the second contact element of the forming unit comprises at least one tip.

17. The method of claim 14, wherein
the first contact element is configured as a first number of first contact pins; or
the second contact element is configured as a second number of second contact pins.

18. The method of claim 17, wherein the first or second contact pins are individually mounted.

19. The method of claim 14, wherein
the first contact element comprises on its contacting end at least one cap having contact spikes; or
the second contact element comprises on its contacting end at least one cap having contact spikes.

20. The method of claim 14, wherein
after the step of pressing the first contact element, the method comprises the following steps
detecting first parameter data of the first contact between the first contact element of the forming unit and the first forming contact-making section of the first conductor,
feeding the detected first parameter data to a controller; and
carrying out a first change to the contact in dependence on the detected first parameter data when the detected first parameter data exhibits a predetermined first threshold value, or
after the step of pressing the second contact element, the method further comprises the following steps
detecting second parameter data of the second contact between the second contact element of the forming unit and the second forming contact-making section of the second conductor,
feeding the detected second parameter data to a controller, and
carrying out a second change to the contact in dependence on the detected second parameter data when the detected second parameter data exhibits a predefined second threshold value.

21. The method of claim 20, wherein
the step of detecting first parameter data of the contact comprises at least one of the following steps
detecting a first transition resistance of the first contact between the first contact element of the forming unit and the first forming contact-making section of the first conductor, or
detecting a first temperature of the first contact between the first contact element of the forming unit and the first forming contact-making section of the first conductor, or
the step of detecting second parameter data of the contact comprises at least one of the following steps
detecting a second transition resistance of the second contact between the second contact element of the forming unit and the second forming contact-making section of the second conductor, or
detecting a second temperature of the second contact between the second contact element of the forming unit and the second forming contact-making section of the second conductor.

22. The method of claim 21, wherein
the step of carrying out a first change to the contact comprises the step of increasing a first pressure with which the first contact element is pressed onto the first forming contact-making section of the first conductor, or
the step of carrying out a second change to the contact comprises the step of increasing a second pressure with which the second contact element is pressed onto the second forming contact-making section of the second conductor.

23. The method of claim 14, wherein the step of carrying out a forming treatment comprises the following steps:
carrying out a first forming of the electrochemical cell in a range of 25 to 40% of nominal capacity;
carrying out a second forming of the electrochemical cell in a range of 75-90% of nominal capacity; and
carrying out a third forming of the electrochemical cell to 100% nominal capacity.

24. An electrochemical cell comprising:
a first conductor having a forming contact-making section configured in a separable manner; and
a second conductor having a second forming contact-making section configured in a separable manner,
wherein the first forming contact-making section is arranged on an outer end of the first conductor and the second forming contact-making section is arranged on an outer end of the second conductor.

25. A battery comprising:
a plurality of electrochemical cells, each comprising
a first conductor having a forming contact-making section configured in a separable manner; and
a second conductor having a second forming contact-making section configured in a separable manner,
wherein the first forming contact-making section is arranged on an outer end of the first conductor and the second forming contact-making section is arranged on an outer end of the second conductor.
